(19) United States
(12) Patent Application Publication
(10) Pub. No.: US 2025/0348289 A1
(43) Pub. Date: Nov. 13, 2025

(54) EXTENDED COMPONENT GENERATION METHOD IN USER INTERFACE PLATFORM DEVELOPMENT SYSTEM AND PROGRAM PERFORMING THIS

(71) Applicant: Inswave Co., Ltd., Seoul (KR)

(72) Inventors: Se Yong EO, Seoul (KR); Woog Lae KIM, Seoul (KR)

(21) Appl. No.: 19/204,616

(22) Filed: May 12, 2025

(30) Foreign Application Priority Data
May 10, 2024 (KR) 10-2024-0061588

(51) Int. Cl. G06F 8/38; G06F 3/04842; G06F 8/34

(52) U.S. Cl. CPC G06F 8/38; G06F 3/04842; G06F 8/34

(57) ABSTRACT

An extended component generation method in user interface platform development system and a program performing this are disclosed. According to one aspect of the present invention, a non-transitory computer-readable medium storing computer executable instructions for performing an extended component generation method when executed by a computer, the method comprising: generating a page for an extended component by a development tool, receiving a selection of one of basic components provided by the development tool, receiving information of an additional function, generating an extended component that inherits all of functions of the basic component and to which the additional function is granted, and registering the extended component with the development tool.

### CROSS-REFERENCE TO RELATED APPLICATION

The present application claims priority under 35 U.S.C. § 119(a) to Korean application number 10-2024-0061588, filed on May 10, 2024, in the Korean Intellectual Property Office, which is incorporated herein by reference in its entirety.

### TECHNICAL FIELD

The present invention relates to extended component generation method in user interface platform development system and program performing the method.

### RELATED ARTS

With the advancement of computer technology, there is a wide variety of software being developed today. To develop software, a program development device is generally used. Previously, developers had to do a lot of manual coding, but now, software is developed more easily using a graphical user interface (GUI).

When developing a program, objects such as buttons, boxes, grids, scroll views that are graphically placed at specific locations on the screen often need to be repositioned, changed to a different parent object, or reordered among siblings, but conventional program development devices have limitations that made it difficult to edit these objects.

As a related patent, Korean Patent No. 10-1282970, filed by the present applicant, discloses a situation-aware positioning device and method for screen objects during program development.

The matters described in the related art are for understanding the background of the invention, and cannot be assumed to be prior art already known to those skilled in the art in the field to which this technology belongs.

### SUMMARY

The present invention is to provide an extended component generation method in a user interface platform development system and program performing the same, that enable a developer to create an extended component that has extended functions while inheriting properties by adding additional functions to a component provided by default in a system, in supporting multi-browser, multi-device, and multi-OS with OSMU (One Source Multi Use).

Other objectives of the present invention will be readily understood through the following description.

According to one aspect of the present invention, there is provided a non-transitory computer-readable medium storing computer executable instructions for performing an extended component generation method when executed by a computer, the method comprising: generating a page for an extended component by a development tool, receiving a selection of one of basic components provided by the development tool, receiving information of an additional function, generating an extended component that inherits all of functions of the basic component and to which the additional function is granted, and registering the extended component with the development tool.

The page for the extended component may be a page having a design tab and a source tab.

The basic component may be a component belonging to at least one type of Forms, Grid, Container, Navigation, Chart, Frame, HTML5, and others.

The extended component may inherit all of properties, events, and APIs of the basic component, but inherits from only one basic component.

According to another aspect of the present invention, there is provided an extended component generation device in a user interface platform development system, including: a page generation unit, configured to generate a page for an extended component by a development tool, a component extension unit, configured to receive a selection of one of basic components provided by the development tool, receive information about an additional function, inherit all of functions of the basic component, and generate an extended component to which the additional function is granted and a registration unit, configured to register the extended component with the development tool.

Other aspects, features and advantages other than those described above will become apparent from the following drawings, claims and detailed description of the invention.

According to one embodiment of the present invention, it is advantageous to enable a developer to create an extended component that has extended functions while inheriting properties by adding additional functions to a component provided by default in a system, in supporting multi-browser, multi-device, and multi-OS with OSMU.

The effects to be obtained from the invention are not limited to those mentioned above, and other effects not mentioned will be apparent to one having ordinary skill in the art to which the invention belongs from the following description.

### BRIEF DESCRIPTION OF ACCOMPANYING DRAWINGS

FIG. 1 exemplarily illustrates the architecture of a user interface platform development system according to one embodiment of the present invention;

FIG. 2 is a diagram comparing the structure of XML code generated by the system according to one embodiment of the present invention and general HTML code;

FIG. 3 is a diagram showing the script execution order when the main screen includes overlapped wframes;

FIG. 4 is a flowchart of the user interface platform development method according to one embodiment of the present invention;

FIG. 5 is a block diagram of an extended component generation device of a user interface platform development system according to one embodiment of the present invention;

FIG. 6 is a flowchart of an extended component generation method according to one embodiment of the present invention

FIG. 7 and FIG. 8 are examples of pop-up windows for entering information of an extended component;

FIG. 9 is a design tab screen showing properties of an extended component and UDC; and

FIG. 10 exemplarily illustrates the configuration of a system according to one embodiment of the present invention.

### DETAILED DESCRIPTION

The invention can be modified in various forms and specific embodiments will be described below and illustrated with accompanying drawings. However, the embodiments are not intended to limit the invention, but it should be understood that the invention includes all modifications, equivalents, and replacements belonging to the concept and the technical scope of the invention.

If it is mentioned that an element is “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

Terms such as first, second, etc., may be used to refer to various elements, but, these element should not be limited due to these terms. These terms will be used to distinguish one element from another element.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

As used herein, a “unit” includes a unit realized by hardware, a unit realized by software, and a unit realized by both. Further, one unit may be implemented using two or more hardware, or two or more units may be implemented using one hardware. In addition, the term “unit” is not meant to be limited to software or hardware, and the “unit” may be configured to reside on an addressable storage medium or may be configured to execute one or more processors. Thus, in one example, “˜unit” may include components, such as software components, object-oriented software components, class components, and task components, processes, functions, properties, procedures, subroutines, segments of program code, drivers, firmware, microcode, circuits, data, databases, data structures, tables, arrays, and variables. The functionality provided within the components and “˜units” may be combined into fewer components and “˜units” or further separated into additional components and “˜subunits”. In addition, the components and “˜units” may be implemented to recycle one or more CPUs in the device.

Elements of an embodiment described below with reference to the accompanying drawings are not limited to the corresponding embodiment, may be included in another embodiment without departing from the technical spirit of the invention. Although particular description is not made, plural embodiments may be embodied as one embodiment.

In describing the invention with reference to the accompanying drawings, like elements are referenced by like reference numerals or signs regardless of the drawing numbers and description thereof is not repeated. If it is determined that detailed description of known techniques involved in the invention makes the gist of the invention obscure, the detailed description thereof will not be made.

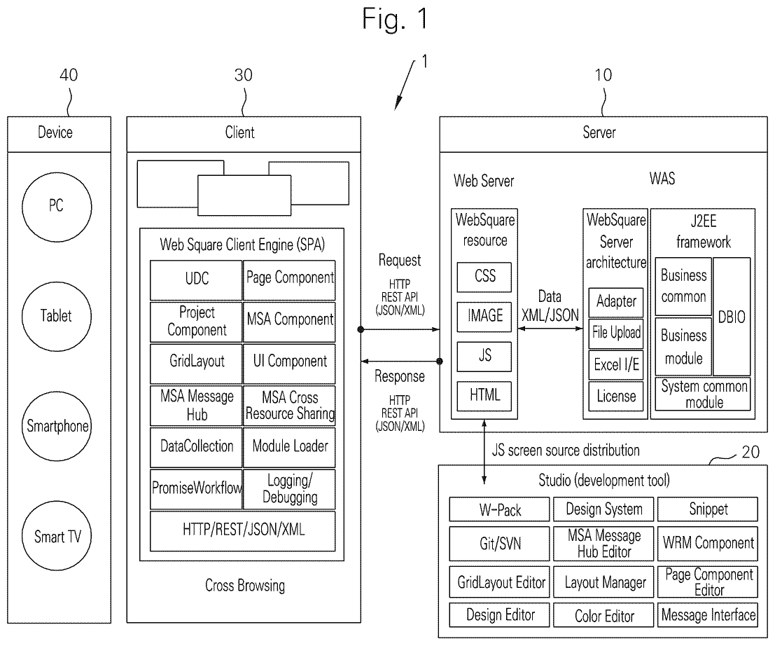

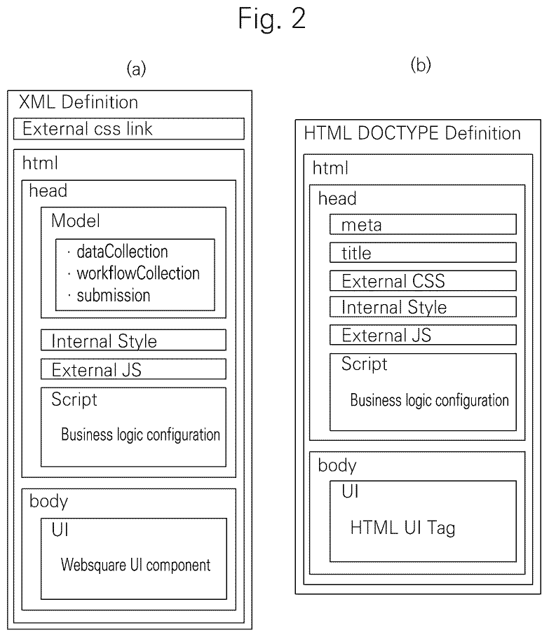

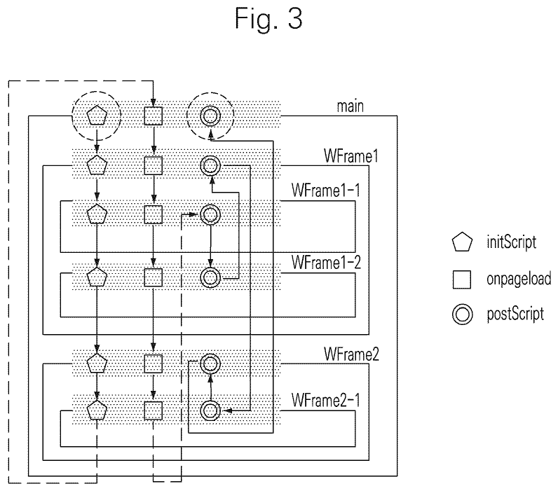

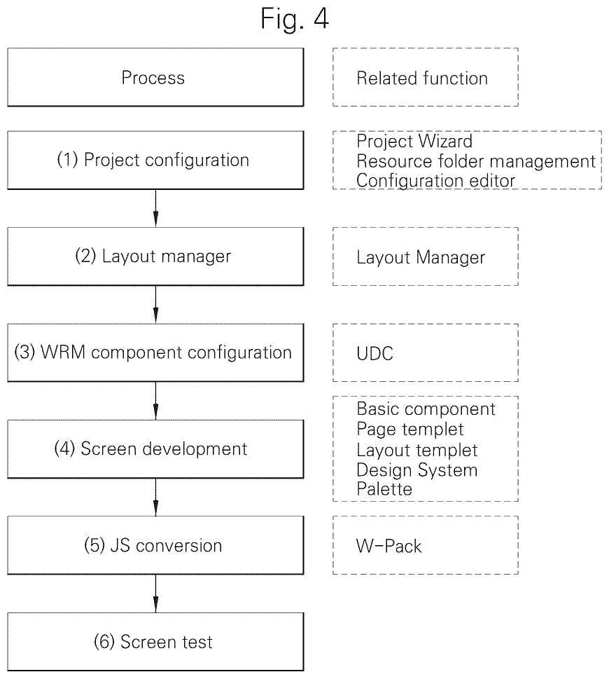

FIG. 1 exemplarily illustrates the architecture of a user interface platform development system according to one embodiment of the present invention, FIG. 2 is a diagram comparing the structure of XML code generated by the system according to one embodiment of the present invention and general HTML code, FIG. 3 is a diagram showing the script execution order when the main screen includes overlapped wframes, and FIG. 4 is a flowchart of the user interface platform development method according to one embodiment of the present invention.

The user interface platform development system 1 according to one embodiment of the present invention supports various smart device and web browser environments of clients, and the server environment supports platform independence for any web application server (WAS) supporting Java 2 Enterprise Edition (J2EE), any framework, any operating system (OS), and the like.

Hereinafter, the user interface platform development software according to one embodiment will be referred to as WebSquare developed and marketed by the present applicant.

The user interface platform development system 1 may include a client 30 used by a user, a development tool 20 used by a developer (sometimes referred to as a “studio”), and a server 10 that responds to requests from the client 30 and enables the development tool 20 to develop WebSquare screen files.

The development tool 20 may provide an environment in which developers can develop WebSquare screen files related to business systems. A client engine may be installed in the client 30, and the client engine may display the WebSquare screen file in the browser.

Client 30 may be written in JavaScript and based on AJAX architecture. It supports dynamic execution of UI components such as grids, charts, etc. It may include utilities for communication and other UI related functions.

The client engine contained in the client 30 may have a Single Page Application (SPA) architecture.

The client engine may include modules such as UDC, Page component, Project component, MSA component, grid layout, UI component, MSA message hub, cross-MSA resource sharing, data collection, module loader, promise workflow, logging/debugging, etc.

Components are basic files that make up a screen of business system and can be used to develop Pages, Project UDCs, MSA UDCs, UDCs, and TTCs. All screens in the business system can be composed of structured components to support efficient operation that can be reused anywhere.

WebSquare Page component is a basic screen file used in component form. Newly added Project UDC, MSA UDC, UDC, and TTC are supported. XML is used as the extension.

UDC stands for User Defined Component, which is registered to a palette in the studio.

TTC stands for Trust Third-part Component and supports the use of external solutions as WebSquare Page components.

Project UDC is a common function file that contains common functions used throughout the Project. It is defined in a WebSquare environment setting and is automatically loaded when a WebSquare engine is loaded.

MSA UDC is a common function file that contains common functions to support micro-frontends. It is defined in the WebSquare environment setting and loads resources from the server where the microservice is running when the corresponding WebSquare engine is loaded.

Components may include built-in components, SP4 UDC components, and WebSquare components.

GridView is a built-in component, and may include Grid, Table, Combo, Input, and TabControl. This component is provided by default in WebSquare.

SP4 UDC components may include SP4 UDC and SPC TTC. As a user-defined component standard, the UDC can be added by a developer on his own. And TTC is an added component products through collaboration with solution manufacturers.

WebSquare component may include UDC, TTC, Project UDC, and MSA UDC. UDC and TTC are Page-based user-defined components introduced to increase the reusability of UI elements (Pages) developed by developers. All Pages can be developed as components by simplifying/structuring existing Pages (XML). It can be modularized by lowering the degree of coupling between Pages.

Project UDC is a global UDC, a component that can be called from any screen. It can be used to develop common task UDCs to maximize reuse.

MSA UDC is a UDC for micro frontend implementation, which applies MSA and enables cross-domain processing.

Data Collection is a module for intuitive, consistent, and convenient data management in the form of tables. It provides an API similar to the Grid component, allowing developers to easily manipulate data in a grid format.

Promise Workflow makes programming asynchronous processing simple and easy with an intuitive GUI that makes it less complicated and difficult to develop with HTML5.

The Server 10 stores application resources (images, HTML, JS, CSS, XML, etc.). The server architecture may include utilities for adapters, file upload/download, Excel I/E (import/export), and license management. It may also include modules for framework interface, business common, business module, DBIO, and system common.

The server 10 may be implemented independently of the OS, DBMS, and WAS, thereby supporting platform independence.

Development tool 20 provides a WYSIWYG-style integrated development environment and can support developers for easy development. A developer can draw components, add scripts, view screens, debug, etc. all at once through the development tool 20.

In addition, the development tool 20 may perform SCM (Software Configuration Management) using SVN/CVS/Git. Commercial configuration management solutions can interoperate as vendor plug-ins provided by vendors.

Development tool 20 may include modules such as a W-Pack (source compiler), a design system, Snippet, Git/SVN, MSA message hub editor, WRM component, a grid layout editor, a layout manager, a Page component editor, a design editor, a code editor, and a message interface. It also supports a reusable common business UDC.

When a client 30 installed on various devices (PCs, tablets, smartphones, smart TVs, etc.) makes a request (HTTP REST API (JSON/XML)) to a server 10, a web server can locate resources, exchange data with a web application server and send a response (HTTP REST API (JSON/XML)) corresponding to the request to the client 30. In the connection between the web server 10 and the development tool 20, JS screen sources may be distributed.

In one embodiment, a micro frontend architecture with MSA message broker and cross-MSA resource sharing capability may be provided to correspond to the microservice architecture (MSA).

In addition, it is possible to improve performance through Single Page Application (SPA), engine optimization (Engine Optimizer), resource optimization (W-Pack), and support for processing large amounts of data.

Through its open architecture, it can support any web application server, any framework, any OS, and improve development productivity through open source reuse. It also supports easy integration of various open/commercial libraries and supports integration with various security solutions.

The XML code generated by WebSquare and the general HTML code structure are compared in (a) and (b) of FIG. 2.

The two main components of WebSquare XML code are the <head> and <body>.

<head> includes <xf:model>, <script>, and <style> elements.

<xf:model> includes <w2:dataCollection>, <xf:workflow>, and <xf:submission>.

<w2:dataCollection> is for defining data objects and includes DataMap, DataList, and LinkedDataList. It defines request and response data for server communication and data to be used on the screen.

<xf:workflow> defines an execution sequence of submit and submitDone. It is used when executing multiple Submissions. It defines the execution sequence, result processing sequence, execution of Submission after the result, etc. It is recommended to use it for communication for the purpose of inquiry (Select).

<xf:submission> defines submit required for service call. Each submit contains a unique ID. As an interface for server communication, multiple definitions are possible for each purpose. It is possible to select a communication method (synchronous/asynchronous), and it is possible to define a function to be executed before/after communication. Data to be transmitted (request or ref) and data to be received (response or target) can be set.

<script> can configure a business logic by defining global scripts and event functions of components.

<style> specifies styles.

<body> includes components, component properties, and screen UI information. As a screen UI information, information about component arrangement and configuration, and properties of each component may be included.

In case of creating WebSquare Page components in this embodiment, the script execution sequence is external JS file->local script-><initScript>->onpageload-><postScript>.

If the main screen contains a nested WFrame, the execution sequence of script is as shown in FIG. 3.

W-Pack, a source compiler, can build screen sources in JavaScript. The screen file developed by the development tool 20 is generated in XML format, and W-Pack converts it into a JavaScript file optimized for the browser environment.

By providing compression and minification (Minify) functions, the file size can be reduced compared to the typical XML format. Obfuscation can be used to increase the security of the source code. JS files optimized for the web environment have shorter loading times and less memory usage compared to XML, so client engines can draw screens on the browser faster by using JS files.

The screen created by the development tool 20 is created as an XML file and converted into JS file by W-Pack, and the XML file name is displayed in the browser, but the file actually used when displaying the screen is the JS file.

The browser's screen calling sequence is as follows:
(1) Browser calls the screen
(2) Websquare.html file of the WebSquare engine on the server side is called
(3) WebSquare engine is running
(4) XML file corresponding to the screen is called with URL
(5) JS file converted by W-Pack is loaded
(6) The corresponding screen is displayed in the browser

The user interface platform development system 1 according to this embodiment provides a variety of common development resources. As a highly complete resource that can be used immediately, it can be provided in the form of a thumbnail image. Developers can intuitively check the template and use the resource easily with just a mouse click without any coding process.

Common development resources may include Page templates (selectable when creating screen files), layout templates (selectable when creating screen files), and Snippets (provided through thumbnail images in the design system).

Referring to FIG. 4, the present system can provide wizards, managers, editors, etc. for each stage according to the development process, and can provide common resources suitable for each stage. By following a development process, a design consistency can be maintained and common resources can be reused as much as possible.

In addition, the present embodiment allows for modularized development. Screen files to be developed can be used in the form of components. When a specific screen is registered and used as a UDC or Project component, it can be reused. When the registered UDC is modified, the changes are reflected in batches, which improves a development productivity and a maintenance efficiency.

Screen files developed in this system can be used in component form (Page component) and support all functions of existing Page files. When a Page is registered as a UDC and used as a common component, a UDC description document can be created based on the annotations on the UDC API, and an auto-completion function for the UDC API can be used in a script editor.

All Pages can be registered as components, and Pages registered as components can be used in other screen development with a simple click.

It is common for components to be integrated and provided as standard in the user interface platform development system 1. The present embodiment is intended to provide a way for developers to simplify the process of creating and registering new components by providing additional function to these components to create extended components and enable new registration.

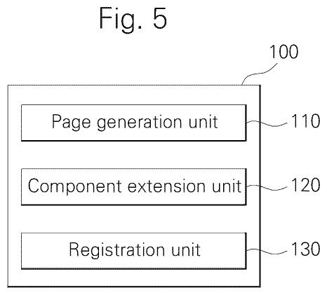

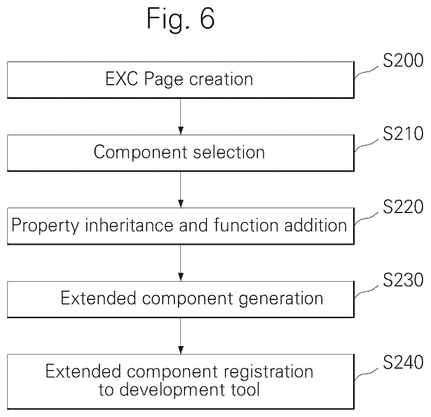

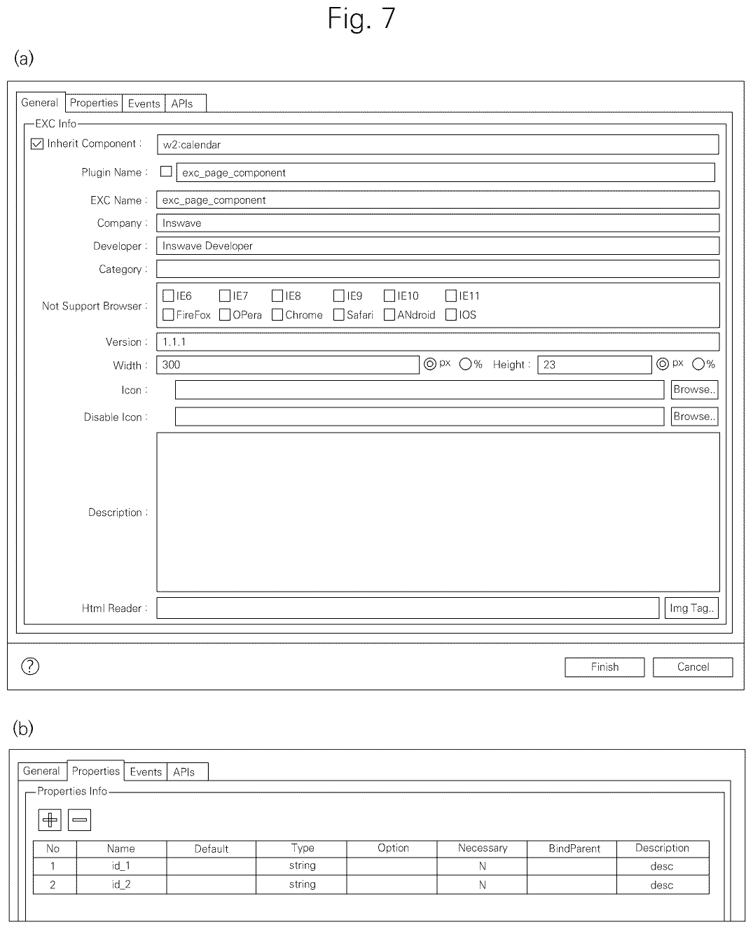

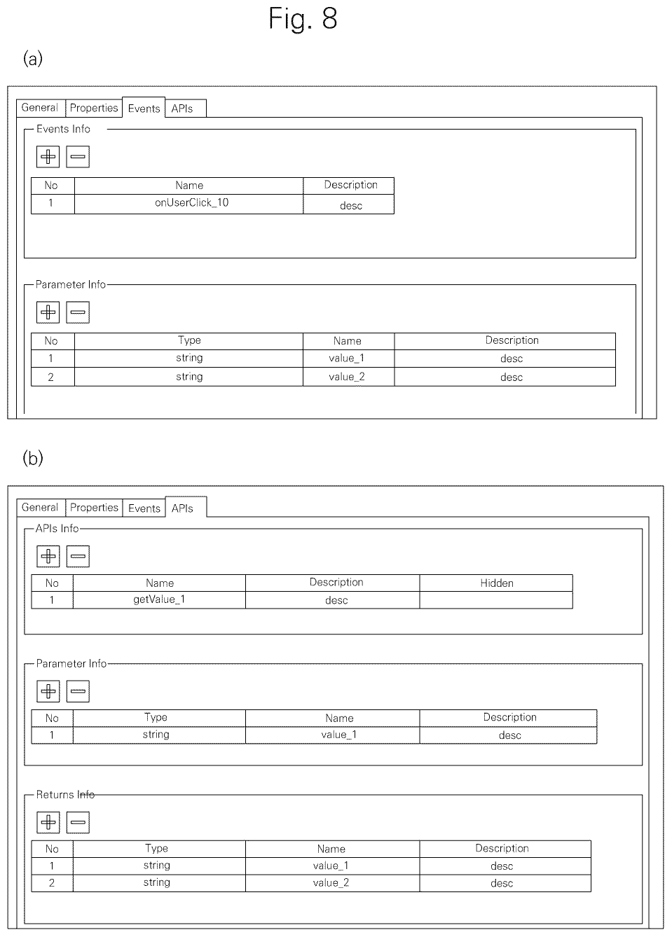

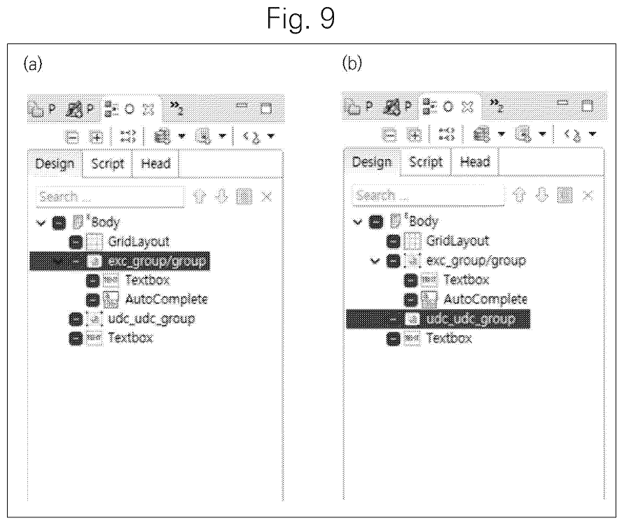

FIG. 5 is a block diagram of an extended component generation device of a user interface platform development system according to one embodiment of the present invention, FIG. 6 is a flowchart of an extended component generation method according to one embodiment of the present invention, FIGS. 7 and 8 are examples of pop-up windows for entering information of an extended component, and FIG. 9 is a design tab screen showing properties of an extended component and UDC.

Referring to FIG. 5, the extended component generation device 100 according to one embodiment of the present invention may include a page generation unit 110, a component extension unit 120, and a registration unit 130.

The extended component generation device 100 may be a software module included in the development tool 20, i.e., the studio. While the development tool 20 is running, the extended component generation device 100 may be activated and operated by user input (e.g., menu selection, shortcut key input, etc.).

The extended component generation device 100 is configured to generate the extended component (EXC, Extended Component) that can be used by granting additional functions tailored to the characteristics of a project while using all functions of the components provided by default in the user interface platform development system 1, and registering it in the development tool 20 so that it can be used later in the corresponding project.

The page generation unit 110 is configured to generate an EXC page for generating an extended component according to user input for generating the extended component (step S200).

The EXC page may be a page having a Design tab and a Source tab.

The Design tab screen is an area where a basic component that serves as the base of an extended component is drawn and the component design is modified as needed.

The Source tab screen is an area where the source code for the basic component that serves as the base of an extended component is displayed. In addition, the Source tab screen can also be updated with source code for features that are added by future input.

The component extension unit 120 is configured to select a basic component to be expanded according to user input on the generated EXC page (step S210). The user can select a basic component to which an additional function is to be granted.

Basic components can include types such as Forms, Grid, Container, Navigation, Chart, Frame, HTML5, and others.

The Form type includes the following basic components.

Anchor component acts as a hyperlink like the <a> tag in HTML. It has functions and features that support various forms through style and class changes. It is configured to provide click events and can support web accessibility.

Accordion component is configured to display content in multiple panels. It includes multiple panels with different content, and has functions and features that allow the developer to add, delete, and open/close each panel. It is used to separate different content into different panels and display them on a single screen.

AutoComplete component extends the function of the SelectBox, and is configured to provide an auto-completion function based on the entered text. It can distinguish between upper and lower case letters, highlight the entered text, and support keyword-included and keyword-matching searches. It can be used as a keyword input box for search.

Calendar component is configured to provide an interface that allows the developer to select a date by outputting a calendar image. It is a date selection tool that allows the developer to specify the date format, set the minimum/maximum year, set the start day of the week, select a skin design, and specify the year/month display order.

CheckBox component is configured to output a checkbox with the items to be selected. It provides an interface similar to the type=“checkbox” of the Input object provided in HTML. Unlike Radio, it is a multi-select menu that allows multiple items to be selected at the same time.

CheckComboBox component is a hybrid of a CheckBox and a SelectBox. It is configured to provide an auto-completion function based on the entered text. It allows multiple selections and can provide a drop-down list-type menu along with the selection box.

DatePicker component is a mobile-only calendar component. It replaces the calendar component and input calendar component in a mobile environment. The top level of the component can use HTML <div>.

Editor component is configured to create a web editor, CKeditor, and providing various functions through options.

FlipToggle component is configured to support toggling through touch dragging. It can be labeled and can be used as a toggling interface for mobile devices.

Image component is configured to display an image on the screen. Images can be added through path settings, and the image size and style can be specified. It is used to insert images onto the screen.

InputBox component is a text input box and is the most basic text input component.

InputCalendar component is configured to provide an interface for directly entering a date or selecting a date from a calendar image.

MultiSelect component is configured to support multiple selections by user. It is a component that supports multiple selections in the form of a select box.

MultiUpload component is configured to provide the ability to upload multiple files at once.

Radio component is configured to provide a selection target item with a selection button, but only allows a single selection.

ScheduleCalendar component is configured to display a schedule in the form of a calendar, and allowing to add, delete, and edit schedules.

SearchBox component is a text input box for searching. It is basically configured to provide the same function as the input box, and can be additionally configured to provide a button to delete the entire text.

Secret component is a text input box and is configured to display the entered text as a separate designated symbol. It can be used as a password input box.

SelectBox component is configured to display a list of selections via a combo box and to provide a drop-down list-style menu that allows only a single selection.

Slider component is configured to provide an interface for selecting values by sliding up, down, left, and right.

Span component is a text box component whose tagname property is span. It can be configured to output a string across the entire width of the web browser.

Spinner component is configured to provide the ability to select values with arrows.

TextArea component is configured to support input/output of newline text. It allows input of multiple lines of text.

TextBox component is a lightweight version of the Output component for simple text output.

Trigger component is configured to provide a button UI and an interface similar to ‘type=button’ of the HTML <input> tag.

Upload component is configured to upload files.

The grid type includes a grid component that is configured to display tabular data in a grid. It is largely divided into Body and Header, and supports various data formats. Grids are freely editable and can support paging, sorting, filtering, and grouping. It can be used for complex table configurations, table configurations that process large amounts of data, and large file uploads/downloads (Excel, CVS, Hansel/Nexel, etc.).

The container type includes the following basic components.

FloatingLayer component is configured to create a new window that is displayed in a pop-up form on the screen. It is displayed on the top layer of the screen, and movement control is possible.

Generator component is a component that is configured to create a component group consisting of multiple components at once. It can be used as an interface for creating a web UI consisting of multiple components.

The Group component is a component that is configured to group multiple components. It can be used to configure the overall layout or implement a complex hierarchy.

ScrollView component is configured to provide mobile-only touch scrolling.

SlideHide component is configured to provide a hiding/showing function through sliding. It can be used in situations where the UI is briefly displayed when the mouse is hovered over, such as a quick menu.

Switch component is configured to generate a screen for each situation when multiple situations are possible and output a screen appropriate for the situation.

TabControl component is configured to generate a tab-type screen. When the TabControl component is drawn, one Tab and its content area are created. Each content can include components in its children, such as Group.

TableLayout component is configured to add HTML5 tags (<colgroup>, <tr>, <td>, <th>) to the tagname property of Group component and to bind them with the <table> tag.

WidgetContainer component is a component that is configured to provide multiple web widgets on one screen. Web widget can be used as the work screen, including server communication. The work screen and utility usage environment can be personalized. Each widget is managed through a different URL, and only the content that the user wants can be placed on one screen. SPA implementation and efficient resource management are possible by using WFrame.

WindowContainer component is configured to control multiple windows using a toolbar.

Navigation type includes the following basic containers:

Accordian component is configured to provide a function to display content in multiple panels.

PageControl component is configured to provide a UI for moving pages.

PageList component is configured to provide the number of pages and an interface for selecting pages.

TreeView component is configured to display hierarchical data in a tree form. Dynamic editing through drag-and-drop is possible, and general data can also be converted into hierarchical data.

chart type includes the following basic components:

FusionChart component is a JavaScript-based chart that works on various devices, browsers, and platforms.

MapChart component is configured to visualize maps in various forms using d3 data.

The frame type includes the following basic components:

IFrame component is similar to the IFrame in HTML. Through the IFrame, it is possible to display WebSquare files, general web content, and other sites on the screen. This is a component that can be applied to the SPA mode.

PageInherit component is configured to insert another WebSquare screen into the current screen.

WFrame component is configured to insert a WebSquare screen, which can be rendered together with the parent page.

HTML5 type includes basic components such as Article, Aside, Audio, Canvas, Footer, Header, Navigation, Section, and Video.

The other types include the following basic components such as an ActiveX component that supports ActiveX use, an Applet component that supports Applet use, and a Flash component that supports Flash use.

Output component is configured to output a string to the browser. ProgressBar component is configured to display the progress status. RounderRectangle component is configured to provide a square with rounded corners. Tag component is a higher-level object that is configured to manage general HTML tags in WebSquare. XHTML component is a plug-in that is configured to display an XHTML file in a layer and to embed an XHTML page. XSL component is configured to output WebSquare XML through XSL.

The component extension unit 120 is configured to receive information about additional functions to be granted to the selected component (step S220). For this purpose, a pop-up window for entering information can be executed.

FIGS. 7 and 8 illustrate examples of pop-up windows for entering information about an extended component. (a) of FIG. 7 is a General input window for entering general information, and (b) is a Properties input window for entering property information to be additionally exposed to the outside. (a) of FIG. 8 is an Events input window for entering events additionally exposed to the outside, and (b) is an APIs input window for entering API information to be additionally exposed to the outside.

The extended component inherits and uses the properties, events, and methods of the selected basic component as they are. In addition, the component is extended by adding features based on the information entered through the popup window.

Therefore, the component extension unit 120 can be configured to create the extended component based on the selected basic component and reflect the information of the additionally entered pop-up window (step S230).

The extended component consists of a design and a source. It follows the UDC2.0 specification. One extended component can inherit from one basic component and can be managed as one xml file.

The registration unit 130 is configured to register the extended component created by the component extension unit 120 in the development tool 20 (step S240) so that it can be utilized when developing a user interface platform such as the work screen.

For example, if the basic component is SelectBox, an extended component that is configured to provide a drop-down list as an additional function can be created and registered. As another example, if the basic component is InputBox, an extended component that is configured to provide additional functions such as maximum input digit control or masking processing can be created and registered.

The extended component according to this embodiment has the following differences compared to the UDC.

In terms of implementation method, the extended component inherits all properties, events, and APIs of the basic component, so there is no need to reimplement them. In contrast, the UDC must newly implement the properties, events, and APIs provided by the UDC.

As a limitation, in the case of the extended component, only one basic component can be inherited. In contrast, the UDC can be implemented by combining multiple components.

In terms of usage, if an extended component inherits Group component, it can act as a container, which is a unique property of the Group. Referring to (a) in FIG. 9, it shows that other components can be created in a subnode of exc_group component.

In contrast, when creating the UDC with Group component, the unique properties of Group cannot be used, and only the properties provided by the UDC can be used. Referring to (b) in FIG. 9, it shows that other components cannot be created in a subnode of udc_udc_group component.

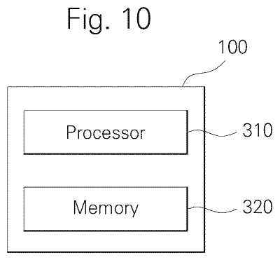

FIG. 10 exemplarily illustrates the configuration of a system according to one embodiment of the present invention.

Referring to FIG. 10, the extended component generation device 100 may include a processor 310 and a memory 320. The memory 320 may store one or more instructions executable by the processor 310. The processor 310 may execute the one or more instructions stored in the memory 320. By executing the instructions, the processor 310 can perform one or more of the operations described above with reference to FIGS. 6 through 9. Additionally, a configuration of the present invention described above with reference to FIG. 5 may be a configuration implemented by instructions executed by the processor 310.

The aforementioned embodiments may be realized by a hardware component, a software component, and/or a combination of hardware and software components. For example, the device and components described in the embodiments may be realized using one or more general-purpose computers or special-purpose computers such as, for example, a processor, a controller, a central processing unit (CPU), a graphics processing unit (GPU), an arithmetic logic unit (ALU), a digital signal processor, a microcomputer, a field programmable array (FPA), a programmable logic unit (PLU), a microprocessor, an application specific integrated circuits (ASICS) or other devices implementing instructions and responding thereto.

The aforementioned extended component generation method may also be implemented in the form of a recording medium including computer-executable instructions, such as an application or program module executed by a computer. The computer-readable medium can be any available medium that can be accessed by a computer, and includes both volatile and non-volatile media, and removable and non-removable media. Further, the computer-readable medium may include a computer storage medium. The computer storage medium includes both volatile and non-volatile, removable and non-removable media implemented with any method or technology for storing information such as computer-readable instructions, data structures, program modules, or other data.

The aforementioned extended component generation method (which may include programs included in platforms or operating systems that are basically installed in the terminal), or it may be executed by an application (i.e., a program) installed by the user directly on the master terminal through an application delivery server, such as an application store server, an application or a web server associated with such a service. In this sense, the aforementioned extended component generation method may be implemented by an application (i.e., a program) installed by default on the terminal or installed directly by the user, and recorded on a computer-readable recording medium such as the terminal.

While the invention has been described above with reference to exemplary embodiments, it will be understood by those skilled in the art that the invention can be modified and changed in various forms without departing from the concept and scope of the invention described in the appended claims.

What is claimed is:

1. A non-transitory computer-readable medium storing computer executable instructions for performing an extended component generation method when executed by a computer, the method comprising:
generating a page for an extended component by a development tool;
receiving a selection of one of basic components provided by the development tool;
receiving information of an additional function;
generating an extended component that inherits all of functions of the basic component and to which the additional function is granted; and
registering the extended component with the development tool,
wherein the extended component inherits all of properties, events, and APIs of the basic component, but inherits from only one basic component.

2. The non-transitory computer-readable medium of claim 1, wherein the page for the extended component is a page having a design tab and a source tab.

3. The non-transitory computer-readable medium of claim 1, wherein the basic component is a component belonging to at least one type of Forms, Grid, Container, Navigation, Chart, Frame, HTML5, and others.

4. An extended component generation device in a user interface platform development system, comprising:
a page generation unit, configured to generate a page for an extended component by a development tool;
a component extension unit, configured to receive a selection of one of basic components provided by the development tool, receive information about an additional function, inherit all of functions of the basic component, and generate an extended component to which the additional function is granted; and
a registration unit, configured to register the extended component with the development tool,
wherein the extended component inherits all of properties, events, and APIs of the basic component, but inherits from only one basic component.

5. The extended component generation device of claim 4, wherein the page for the extended component is a page having a design tab and a source tab.

6. The extended component generation device of claim 4, wherein the basic component is a component belonging to at least one type of Forms, Grid, Container, Navigation, Chart, Frame, HTML5, and others.
